(19) United States
(12) Patent Application Publication
(10) Pub. No.: US 2023/0352815 A1
(43) Pub. Date: Nov. 2, 2023

(54) Dual-Polarized Multi-Band Base Station Antenna Arrays

(71) Applicant: GALTRONICS USA, INC., Tempe, AZ (US)

(72) Inventors: Abdolmehdi Dadgarpour, Ottawa (CA); Farid Jolani, Ottawa (CA); Sadegh Farzaneh, Ottawa (CA); Zhihua Yu, Ottawa (CA); Jacco Van Beek, Ottawa (CA)

(73) Assignee: GALTRONICS USA, INC., Tempe, AZ (US)

(21) Appl. No.: 17/790,448

(22) PCT Filed: Jan. 18, 2022
(86) PCT No.: PCT/US2022/012735

§ 371 Date: Jun. 30, 2022

Related U.S. Application Data
(60) Provisional application No. 63/138,659, filed on Jan. 18, 2021.

(51) Int. Cl. H01Q 1/24; H01Q 1/52; H01Q 5/385; H01Q 21/26

(52) U.S. Cl. CPC H01Q 1/246; H01Q 1/523; H01Q 5/385; H01Q 21/26

(57) ABSTRACT

A dual-polarized multi-band base station antenna array having a reduced physical footprint with compact antenna elements for deployment in wireless communication systems. The array includes a wall structure for suppressing air coupling between adjacent antenna element columns and for reducing the surface wave. Also described is a swapping technique for improving beamwidth and sector power ratio, and a low-profile antenna element for minimizing cross-band scattering, reducing impact on low-band antenna arrays, and improving passive intermodulation.

### TECHNICAL FIELD

The present invention relates to base station antenna arrays. More specifically, the present invention relates to reduced footprint, compact antenna arrays deployed in wireless communication systems.

### BACKGROUND

Within fourth generation (4G) and fifth generation (5G) wireless communication systems, there are base stations that consist of different antenna arrays operating at different frequency bands. Such varied operating bands in a single base station is a key part of cellular communication systems and provides enhanced services for users and increases the channel capacity of the wireless systems. A typical goal is to design such a base station which is narrow in physical width and has a low physical profile to reduce the wind load impact upon the antenna structure that houses the base station. In addition, it is desirable to fit an increased number of antenna arrays within a limited space so as to save cost and achieve better performance in terms of gain, isolation, and cross polarization. However, providing, in single base station, additional antenna arrays which function at different frequency bands results in destructive interactions and this, in turn, affects antenna performance in terms of isolation, cross polarization, and azimuth beamwidth.

Generally, 4G and 5G antenna elements within base stations operate in the frequency range of 617-960 MHz, 1.695-2.69 GHz, and 3.3-4.2 GHz. In such modern base station antenna arrays, there are two columns of low-band arrays (617-960 MHz) with four ports which may be used for 2×2 or 4×4 Multiple-Input/Multiple-Output (MIMO) implementations. It should be noted, however, that the placement of multiple arrays operating in different frequencies in the same base station must conform to a number of limitations. For instance, to design a 4×4 MIMO antenna with a frequency range of 698-896 MHz, there should be enough distance between adjacent columns to avoid any destructive interaction. However, due to the limited width of a reflector (with the width typically being less than 500 mm) it is not feasible to locate each of the LB arrays far from each other. Additionally, when the LB arrays are shifted toward the edge of the reflector, the front-to-back ratio (FBR) is degraded.

The common solution to reflector reduced width and high FBR is to move each column of LB arrays toward the center of the reflector to around 0.5 wavelength of the lowest frequency. Provided that one LB column is excited, this will induce a 180 degree out of phase current distribution on the adjacent column and this will widen the 3 dB azimuthal radiation beyond 65 degrees. However, within 4G and 5G cellular communication systems it is required that each sector corresponding to one base station antenna has a 3 dB azimuth beamwidth of around 65 degrees to avoid any interference with adjacent cells. Another parameter affecting pattern diversity of MIMO systems is the co-isolation between each polarization of two adjacent columns.

The common method for improving the co-isolation and cross-isolation between two columns of LB arrays is to utilize shorted parasitic fences as well as floating fences. However, this approach widens the azimuth radiation pattern and deteriorates the side-lobe level (SLL) on the elevation plane, respectively. Another approach is to use a staggered configuration for the entire array. However, this approach increases the aperture area of the array in the azimuth plane, resulting in a narrowing of the 3 dB azimuth pattern. This also deteriorates the co-isolation and cross-isolation and reduces the total gain of LB arrays.

There is, therefore, a need for antenna structures that overcome the defects of known techniques.

### SUMMARY

The present invention relates to a dual-polarized multi-band base station antenna array having a reduced physical footprint with compact antenna elements for deployment in wireless communication systems. The array includes a wall structure for suppressing air coupling between adjacent antenna element columns and for reducing the surface wave. Also described is a swapping technique for improving beamwidth and sector power ratio, and a low profile antenna element for minimizing cross-band scattering, reducing impact on low-band antenna arrays, and improving passive intermodulation.

In a first aspect, the present invention provides a dual-polarized multi-band base station antenna array, said array comprising: a first arrangement of antenna elements operating in a first band; a second arrangement of antenna elements operating in a second band; a wall structure provided between said first arrangement and said second arrangement.

In another aspect, the present invention provides an antenna array, said array comprising:
a first arrangement of antenna elements operating in a first frequency band;
a second arrangement of antenna elements operating in a second frequency band;
a metal wall structure provided between said first arrangement and said second arrangement.

In yet another aspect, the present invention provides an antenna array comprising: a first linear array of first antenna elements, a second linear array of second antenna elements, and a metal wall structure located between said first linear array and said second linear array, wherein said first linear array, said second linear array, and said metal wall structure are parallel to one another.

### BRIEF DESCRIPTION OF THE DRAWINGS

The present invention will now be described by reference to the following figures, in which identical reference numerals refer to identical elements and in which:

FIG. 1 is a schematic of a multi-port base station antenna array with a wall structure in accordance with the present invention;

FIG. 2 is a schematic of the wall structure showing one possible configuration of layers;

FIG. 3 is a schematic of a modified wall structure shown assembled and in exploded view showing another possible configuration of layers;

FIG. 4 is a schematic of another antenna array with a wall structure in accordance with the present invention;

FIG. 5 shows graphical representations of measured inter-band and intra-band isolation between two columns of low-band arrays (a) without a wall structure, (b) with a wall structure in accordance with the present invention;

FIG. 6 shows arrangements showing (a) a specific low-band antenna array configuration and (b) a generalized antenna configuration and which both include element swapping on the top and bottom elements of LB arrays in accordance with another aspect of the present invention;

FIG. 7 shows yet another possible element swapping technique including only on the bottom element of LB arrays in accordance with the present invention;

FIG. 8 shows a configuration of a low-profile, mid-band antenna element in accordance with yet another aspect of the present invention provided alternatively with (a) two parasitic elements and (b) one parasitic element;

FIG. 9 shows a graphical representation of S-parameters of the inventive low-profile, mid-band antenna of FIG. 8 and utilized in the antenna arrays in accordance with the present invention; and

FIG. 10 shows a graphical representation of realized gain of the inventive low-profile, mid-band antenna with double parasitic elements illustrated in (a) of FIG. 8 and utilized in the antenna arrays in accordance with the present invention.

### DETAILED DESCRIPTION

The present invention mitigates the above-mentioned issues with regard to known 4G and 5G antenna structures.

The present invention includes a novel structure referred herein as a soft-surface wall (or simply a “wall structure”) consisting of spaced apart layers of reflective, non-ferromagnetic metal (e.g., aluminum, brass, etc.) which has an advantageous impact on improving the isolation (by blocking air coupling and reducing surface waves) on the common ground plane of LB columns in an antenna array. Additionally, this wall structure helps in obtaining a better 3 dB azimuth beamwidth and improves the FBR.

To further improve the 3 dB azimuth beamwidth of LB arrays, another aspect of the present invention includes a swapping technique whereby swapping of the LB elements for the first and last element of low-band arrays occurs between adjacent LB columns.

In one implementation, the present invention includes a mid-band (MB) antenna that consists of a half wavelength dipole at the center frequency (e.g., 2.2 GHz), a wideband balun, and a parasitic element. The balun is located vertically into the reflector and is capacitively connected to the half wavelength dipole. The height of the dipole is usually about 34 mm and the total height of the MB element with the parasitic element is 42 mm. Due to the large height of the balun of the MB element, the side-lobe-level (SLL) of the elevation pattern at the higher part of low frequency band (such as 800 MHz) is degraded. This large height also widens the azimuth beamwidth of LB arrays to around 80 degrees. However, to alleviate this issue, the present invention also includes an optimized MB antenna element that includes balun whose total height is restricted to 20 mm. This advantageously helps to substantially not degrade the SLL of the elevation radiation pattern of the LB array.

The present invention therefore improves the co-isolation and cross-isolation between two adjacent columns of LB arrays.

The inventive wall structure is intended to be placed between two adjacent columns of LB arrays and the wall structure assists in significantly improving co-isolation between these columns. Because the wall structure reduces mutual coupling by blocking air coupling and reduces surface waves between the adjacent columns, the 3 dB azimuth beamwidth of excited LB arrays is, accordingly, not affected by the other adjacent LB arrays.

As noted above, to minimize the impact of the MB antenna element as well as to assist in the SLL of the elevation pattern on the azimuth radiation of LB arrays, the inventive low-profile, wideband MB element is provided as having a vertical balun with a height that is, at most, 20 mm.

The three primary aspects of the present invention therefore include: the inventive wall structure for suppressing the air coupling and reducing the surface wave; the inventive swapping technique for improving the 3 dB azimuth beamwidth and sector power ratio; and the inventive low profile MB antenna for minimizing cross-band scattering and reducing its impact on LB antenna arrays as well as for improving the PIM performance level to better than −153 dBc over a frequency range of the low band frequency band (617-960 MHz)

In general, a cellular communication system may be comprised of hexagonal cells, where each cell has a triangular antenna tower. Basically, the antenna tower in each cell consists of three sectors, where each sector corresponds to 120-degree coverage, and each sector is divided into one or more base station antennas to facilitate frequency re-use and to increase the channel capacity of wireless systems. In modern base station antennas, different frequency bands for technologies such as Long Term Evolution (LTE) and MIMO have been defined to fulfil the high demand of users. Thus, the present invention advantageously allows for the fitting of more columns of linear antenna arrays, operating at different frequency bands, into a narrow width reflector. This provides more advantages such as cost reduction as well as reducing the impact of wind load on the antenna towers.

To implement MIMO technology and to reduce the fading impact, it is common to use interleaved columns of Low-band (LB) and Mid-band (MB) arrays with slant polarization beside each other in one reflector. For instance, two columns of LB arrays working over the frequency range of 698-896 MHz along with two columns of mid-band arrays operating in the frequency band of 1.695-2.69 GHz are accommodated in a reflector having a width of less than 500 mm. However, due to the close spacing between the columns of the antenna arrays, there is a strong mutual coupling between the columns. This adversely affects antenna performance such as far-field radiation, as well as isolation.

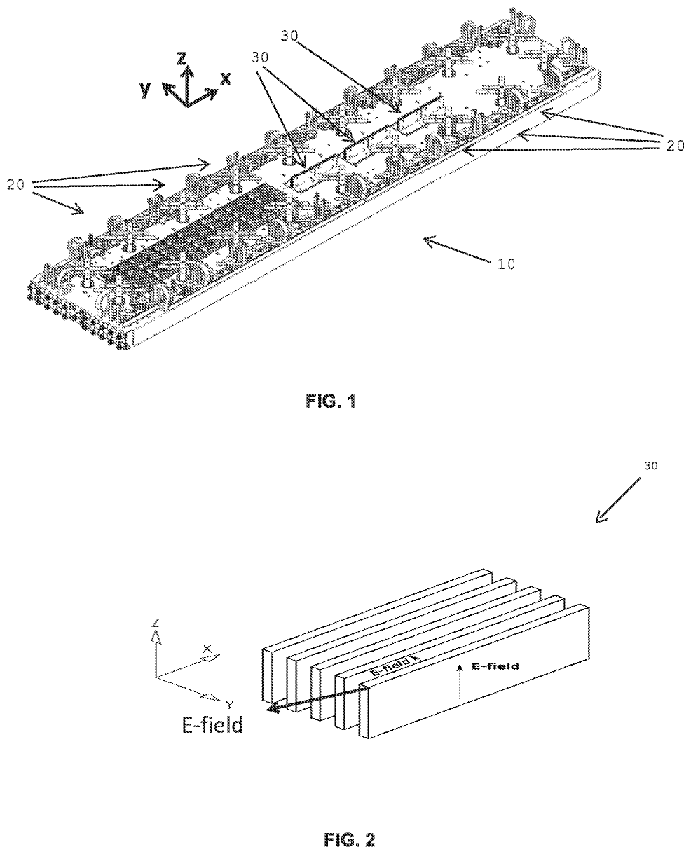

With reference to FIG. 1, there is shown a schematic of a multi-port base station antenna array with a wall structure in accordance with one aspect of the present invention. From the figure, it can be seen that the antenna 10 has two columns of Low band arrays 20 (each array being a 1×9 array) laid along the x-axis. These columns 20 are located close to each other in the center of reflector to achieve better front-to-back ratio. However, by exciting one column of a LB array, a 180 degree out of phase current distribution is induced on the adjacent column. This widens the radiation pattern in the azimuth plane. Additionally, because two columns of LB arrays are close to each other, the inter isolation of two adjacent columns would be degraded. To mitigate the above-mentioned issues, an inventive wall structure 30 is provided.

It can be seen from FIG. 1 that each column of the array forms a linear array of antenna elements, with one column forming a first array and a parallel column forming a second array of antenna elements. The inventive wall structure is placed parallel to each of the first and second arrays and is, preferably, placed in the center of the overall base station antenna array.

Referring to FIG. 2, the figure shows a schematic of the wall structure, illustrating one possible configuration of the layers in the wall structure.

The wall structure shown in FIG. 2 is comprised of five metal layers parallel to one another with a specific air gap separating each metal layer from adjacent metal layers. The purpose of the vertical metal layers is to suppress the electric field polarized along the z-axis, in particular when the Transverse Electric (TE) mode exists in the near-field between two adjacent columns of low-band arrays. To suppress the Transverse Magnetic (TM) modes existing in the gap between each pair of metal layers, the height of the grounded wall structure is selected as about quarter wavelength at center frequency of the low frequency band. The metal layers can be constructed out of non-ferromagnetic material such as aluminum or bronze.

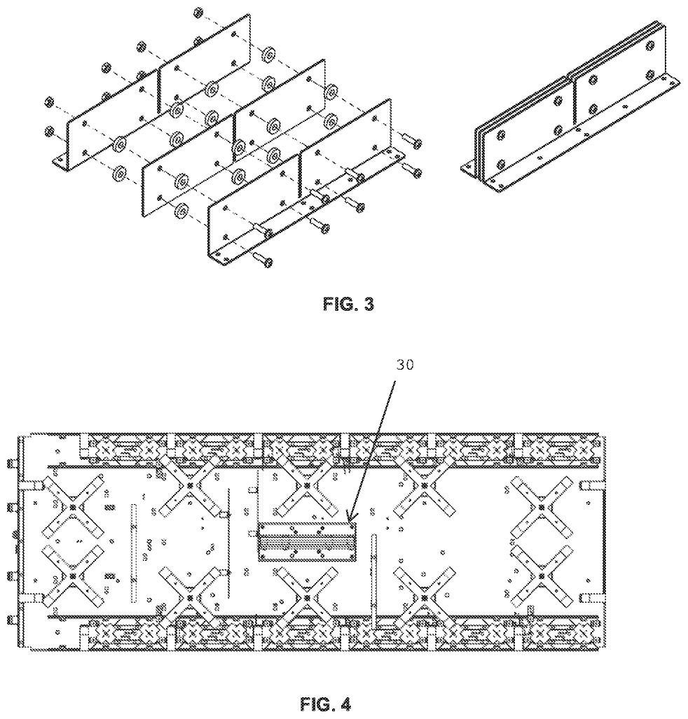

It should be understood that the wall structure may be designed as having between three to five layers. While using five layers minimizes the inter-column isolation, a three-layer wall structure provides a balanced compromise between inter-column isolation improvement and design simplicity. One such three-layer implementation is shown in FIG. 3. FIG. 3 shows a schematic of a modified wall structure shown assembled and in exploded view and shows another possible configuration of layers.

The inventive wall structure suppresses the TE and TM surface waves existing between two adjacent columns of low band antenna arrays and common ground plane and considerably suppresses the co-polarized isolation. While the inventive wall structure does reduce the inter isolation, there remains a destructive impact on the cross-polarized isolation by directing the signal from the +45 polarization to −45 polarization of two adjacent low-band columns. To alleviate this issue, the wall structure of the present invention may be further modified as shown in FIG. 3. It can be seen in FIG. 3 that the longitudinal cross-section of the wall structure is divided into two sections by having a notch in the middle of the wall. As a result, the configuration as shown in FIG. 3 does not affect the cross-polarized isolation but still reduces the inter isolation. While a single notch is shown, it should be readily apparent that any number of notches may be utilized to provide for the desired level of inter isolation. Likewise, although a single notch is shown within each of the three plates in the figure, it should be understood that providing for multiple sets of parallel plates where each set is separate by a gap would provide the same effect as a notch without straying from the intended scope of the present invention. It should also be clear that, for this configuration, each layer has a notch and all the notches across all the layers are aligned.

FIG. 4 shows one implementation of such a wall structure in accordance with the present invention and in combination within an antenna array. As may be seen from FIG. 4, the wall structure is preferably in the center of the overall antenna array. This is due to signal power strength being higher at the core (i.e., central) antenna elements on the array.

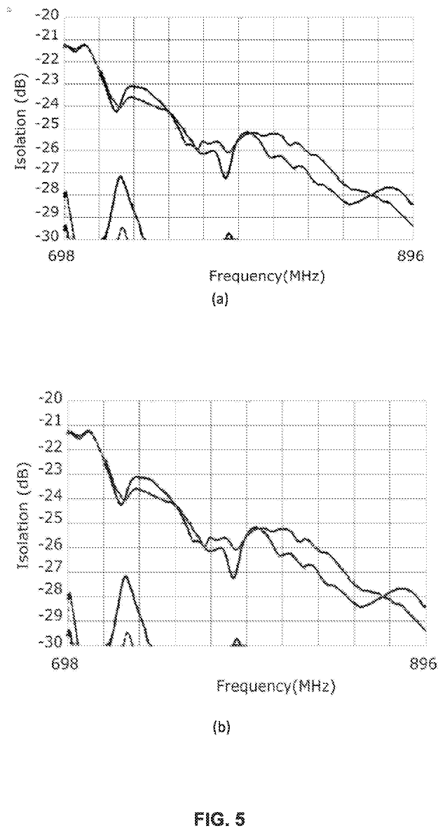

The resulting co-isolation and cross-isolation between two adjacent columns of LB antenna arrays is shown in FIG. 5. FIG. 5 includes graphical representations of measured same column cross-polarization and inter-column isolation between two columns of low-band arrays without a wall structure between the two columns (FIG. 5(a)) and with a wall structure according to the present invention between them (FIG. 5(b)). It can be seen that when one set of wall structures is placed between two adjacent columns of LB arrays, the co-polarized isolation is improved by 7.5 dB at 698 MHz.

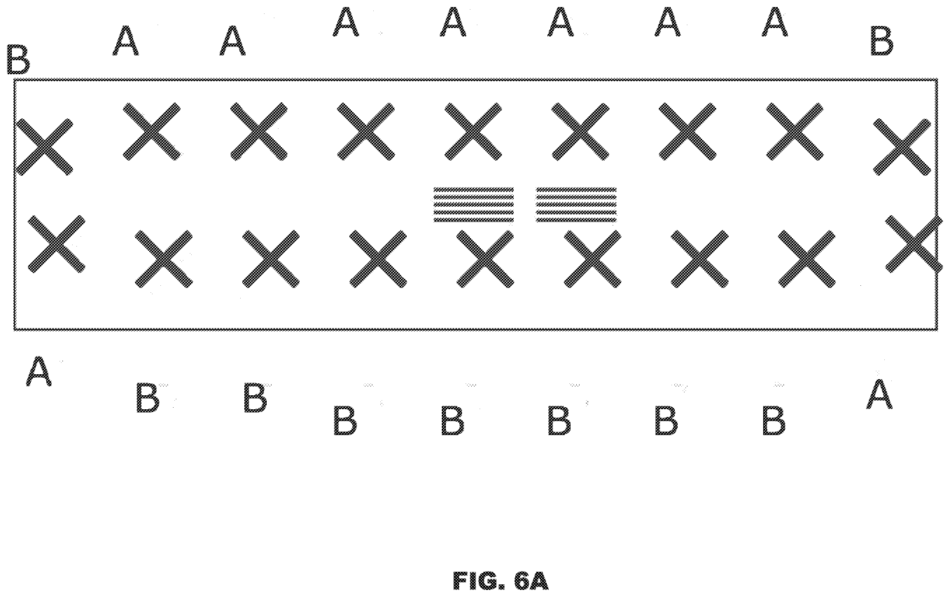

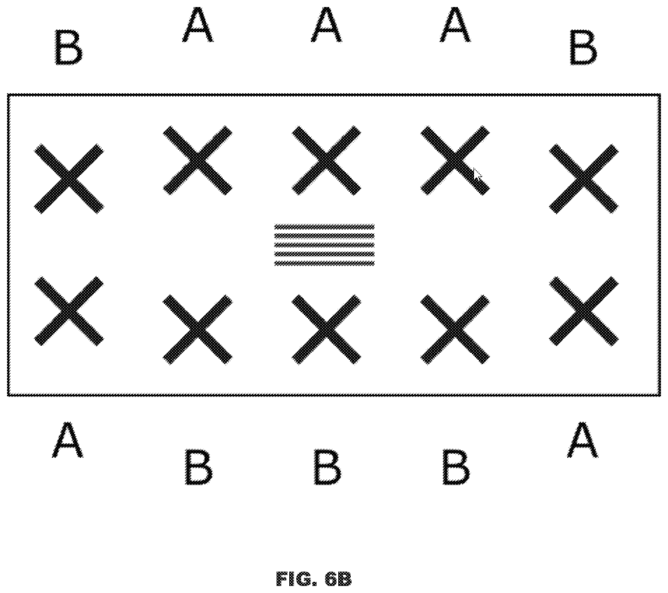

Another advantage of implementing the inventive wall structure is that the wall structure improves the azimuth beamwidth of LB antenna arrays. Because the inventive wall structure prohibits the coupling of the EM waves from one column to another adjacent column along the x-direction, an azimuth beamwidth in the range of 65±5 degrees may be achieved when compared with LB antenna arrays that do not have the inventive wall structure. However, for some frequencies, in particular frequencies in the lower part of the low band, the azimuth beamwidth widens. This has a destructive impact on the neighbouring sectors and causes interference. Thus, to obtain an azimuth beamwidth of less than 60 degrees and to achieve a better sector power ratio, the arrangement of low-band antenna arrays as shown in FIG. 6(a) may be used.

Referring to FIG. 6, FIG. 6(a) shows a specific low-band antenna array configuration while FIG. 6(b) illustrates a generalized antenna configuration. Both FIGS. 6(a) and 6(b) include element swapping on the top and bottom elements (i.e., at the ends of the antenna arrays) of LB arrays in accordance with another aspect of the present invention.

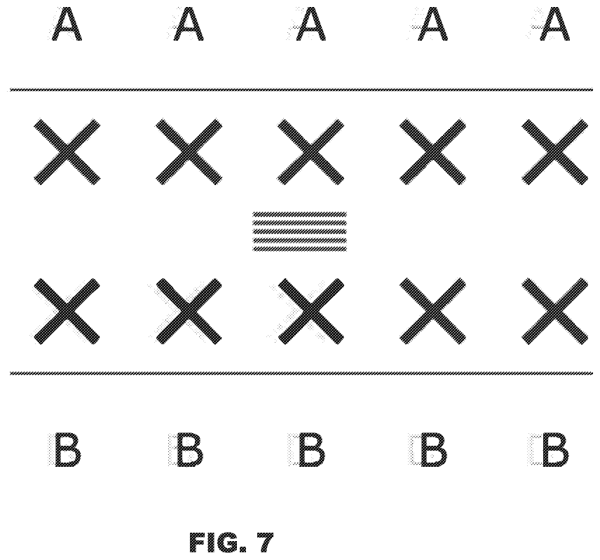

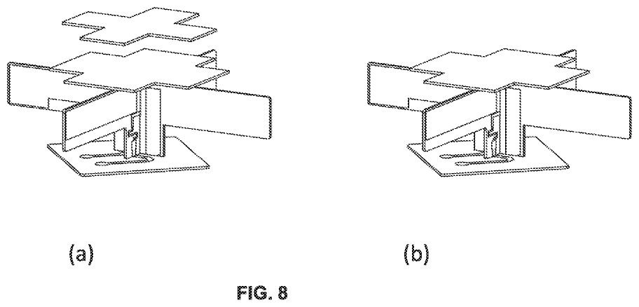

The element swapping aspect of the present invention, as shown in FIG. 6(b), involves swapping the top and bottom elements (i.e., the end elements) of low-band arrays A and B with the adjacent columns. This swapping technique provides a narrower azimuth beamwidth and less sector power ratio percentage in comparison without such swapping. The narrower azimuth beamwidth and the lower sector power ratio are two main factors for reducing interference. Another type of element swapping including only on the bottom (or only at one end of the antenna arrays) may be used and is shown in FIG. 7. In FIG. 7, it can be seen that the end elements of the two linear arrays are swapped such that the end element of array A is closer to array B while the end element of array B is closer to array A. The reason to employ one element swapping either at bottom or top of the arrays instead of applying at both ends is due to the high gain characteristic of the LB elements. In fact, in FIG. 7 low band elements with high gain characteristic are used.

It should be clear that the element swapping aspect of the present invention is useful for two linear arrays that are adjacent to one another. An end element A for a first array is placed such that the end element A is closer to the second array at a position that is at one end of the second array. Similarly, an end element B for the second array is placed such that this end element B for the second array is closer to the first array at a position that mirrors end element A's placement.

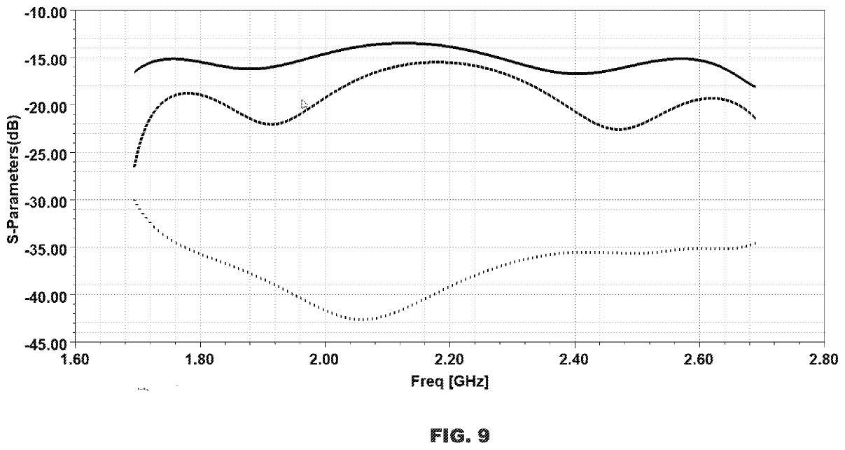

It should be understood that another cross-band scattering that occurs in an interleaved multiband base station antenna is the effect of mid-band antenna elements on the low-band elements. When the low-band antenna radiates, some portions of current distribution are induced on the mid-band element as well as on parallel baluns. Those induced currents that exist on the dipole's arm and baluns of the mid-band element resonate at the low frequency band and have a destructive impact on the far-field radiation pattern of low-band frequencies in the azimuth and elevation plane. This brings about a gain drop at low band frequencies and this affects the side-lobe-level (SLL) in the elevation plane. Most importantly, these induced currents and their resonance widens the azimuth radiation pattern of low band antenna arrays. To mitigate these issues, the present invention also provides for the advantageous dipole antenna element as shown in FIG. 8. The dipole antenna element in FIG. 8 provides a configuration for a low-profile, mid-band antenna element in accordance with yet another aspect of the present invention. FIG. 8(a) illustrates one configuration with two parasitic elements while FIG. 8(b) shows a configuration with only one parasitic element. These inventive configurations are comprised of a balun which capacitively feeds the dipole while two parasitic elements improve the impedance matching and enhance the gain at higher frequencies. The antenna element has a short physical height, and its vertical structure is capacitively coupled to its horizontal structure.

The height of balun in the antenna element has an advantageous role for widening the azimuth radiation pattern of the low-band antenna. By reducing the height of the mid-band element (which results in a reduction of the balun's height) the common-mode resonance shifts out of the low frequency bandwidth. However, by reducing the height of the balun or dipole, the impedance matching, and inter-band isolation become degraded. To realize this, different parameters are optimized to reduce the height of the balun and to obtain good matching as well as isolation over a frequency band of 1.695-2.7 GHz. The height of the balun is preferably one quarter wavelength at the center frequency of the bandwidth.

FIG. 9 shows a graphical representation of S-parameters of the inventive low-profile, mid-band antenna element of FIG. 8 when used in antenna arrays. The resulting S-parameters of the antenna, when simulated in a high frequency structure, is shown in FIG. 9. FIG. 9 shows that the isolation is better than 30 dB over a large frequency bandwidth of 1.695-2.69 GHz.

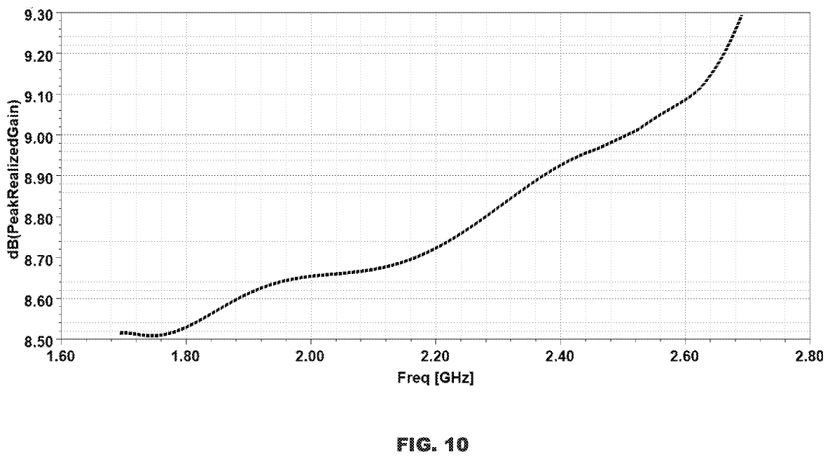

FIG. 10 shows a graphical representation of the realized gain of the inventive low-profile, mid-band antenna with double parasitic elements (shown in FIG. 8(a)) when used in an antenna array. One main advantage of shortening the dipole's height is that it allows for increasing gain at a higher part of the frequency band as may be seen from FIG. 10. Indeed, the antenna realized gain varies from 8.5-9.3 dBi in the frequency band of 1.695-2.69 GHz. Because a MB antenna incorporating the present invention would have a low-profile balun height, this shifts the resonance out of the low band frequency band. Such a MB antenna configuration would also provide improved Passive Intermodulation (PIM) performance in a frequency range of 617-960 MHz.

It should be understood that the difference between the two configurations shown in FIGS. 8(a) and 8(b) is that the antenna element with two parasitic elements achieves higher gain than the antenna element with a single parasitic element.

The present multi-port base station antenna array in accordance with the above referenced inventive aspects can operate in the frequency range of 617-960 MHz, 1.695-2.69 GHz and 3.3-4.2 GHz, and may be deployed for 4G wireless communication systems as well as for massive MIMO 5G applications.

A person understanding this invention may now conceive of alternative structures and embodiments or variations of the above all of which are intended to fall within the scope of the invention as defined in the claims that follow.

1. An antenna array, said array comprising:
a first arrangement of antenna elements operating in a first frequency band;
a second arrangement of antenna elements operating in a second frequency band;
a metal wall structure provided between said first arrangement and said second arrangement,
wherein said wall structure includes at least three layers of metal, at least one pair of layers of said at least three layers being separated by an air gap.

2. (canceled)

3. The array as claimed in claim 1, wherein said metal is non-ferromagnetic.

4. The array as claimed in claim 1, wherein said first arrangement and said second arrangement are substantially aligned along an axial length of said array and at least one antenna element operating in said first band is axially adjacent to at least one antenna element operating in said second band.

5. The array according to claim 1, wherein said first arrangement forms a linear array of antenna elements.

6. The array according to claim 1, wherein said second arrangement forms a linear array of antenna elements.

7. The array according to claim 1, wherein said first arrangement forms a first linear array of first antenna elements and said second arrangement forms a second linear array of second antenna elements, said first linear array being parallel to said second linear array.

8. The array according to claim 7, wherein said metal wall structure is arranged parallel to both said first linear array and said second linear array.

9. The array according to claim 1, wherein said at least three layers each comprise a metal plate, said layers being parallel to one another and each layer being separated from adjacent layers by an air gap.

10. The array according to claim 7, wherein a first end element from said first linear array is placed closer to said second linear array than to said first linear array, said first end element being located at an area corresponding to an end of said first linear array.

11. The array according to claim 10, wherein a second end element from said second linear array is placed closer to said first linear array than to said second linear array, said second end element being located at said area.

12. The array according to claim 7, wherein a first end element from said first linear array is placed closer to said second linear array than to said first linear array and wherein a second end element from said second linear array is placed closer to said first linear array than to said second linear array, said first end element corresponding to said second end element and said first and second end elements being located at an end of said both said first and second linear array.

13. The array according to claim 9, wherein each metal plate comprises a notch, each metal plate being placed such that notches for all of the at least three layers of metal plates are aligned with one another.

14. The array as claimed in claim 1, wherein each antenna element within said array is formed by a low-profile structure.

15. The array as claimed in claim 14, wherein each said low profile structure includes a short vertical element capacitively coupled to a horizontal element.

16. The array according to claim 14, wherein at least one antenna element in said array has at least one parasitic element.

17. The array according to claim 14, wherein at least one antenna element in said array has two parasitic elements.

18. The array according to claim 15, wherein said horizontal element is a parasitic element.

19. The array according to claim 15, wherein said low profile structure includes at least two parasitic elements.

20. The array according to claim 1, wherein said antenna array is a dual-polarized multi-band base station antenna array.

21. An antenna array comprising: a first linear array of first antenna elements operating in a first frequency band, a second linear array of second antenna elements operating in a second frequency band, and a metal wall structure located between said first linear array and said second linear array,
wherein said first linear array, said second linear array, and said metal wall structure are parallel to one another and wherein said wall structure includes at least three layers of metal, at least one pair of layers of said at least three layers being separated by an air gap.
